(19) United States
(12) Patent Application Publication
(10) Pub. No.: US 2006/0132678 A1
(43) Pub. Date: Jun. 22, 2006

(54) Color filter substrate and liquid crystal display device

(75) Inventors: Katsuhiro Kikuchi, Nara (JP); Makoto Ohue, Nara (JP); Takeshi Ishida, Nara (JP); Ikuji Konishi, Mie (JP); Kohichi Fujimori, Mie (JP)

Correspondence Address: NIXON & VANDERHYE, PC, 901 NORTH GLEBE ROAD, 11TH FLOOR, ARLINGTON, VA, 22203, US

(73) Assignee: Sharp Kabushiki Kaisha, Osaka (JP)

(21) Appl. No.: 11/300,410

(22) Filed: Dec. 15, 2005

(30) Foreign Application Priority Data
Dec. 17, 2004 (JP) 2004-366217

(51) Int. Cl. G02F 1/1335

(52) U.S. Cl. 349/106

(57) ABSTRACT

In the liquid crystal display device of the present invention, a filter of, for example, red, green, or blue is formed on a glass substrate surface of a liquid crystal layer side, and if necessary, a black mask is formed between the filters. The filter has a first region and a second region with a film thickness thinner than that of the first region. The second region has, on the inside, an uncolored region where the filter is not formed. In one pixel region, the first region is formed so as to correspond to a transmissive region and the second region and the uncolored region are formed so as to correspond to a reflective region. A reflective electrode and a transparent electrode are formed on another glass substrate surface of the liquid crystal layer side.

### REFERENCE TO RELATED APPLICATION

This Nonprovisional application claims priority under 35 U.S.C. § 119 (a) on Patent Application No. 2004-366217 filed in Japan on Dec. 17, 2004, the entire contents of which are hereby incorporated by reference.

### BACKGROUND OF THE INVENTION

1. Field of the Invention

The present invention relates to a liquid crystal display device displaying images by both reflective display and transmissive display, and a color filter substrate used for the device.

2. Description of the Related Art

Currently, liquid crystal display devices are used widely in electronic apparatuses such as a monitor, a projector, a mobile phone, a Personal Digital Assistant (hereinafter, referred to as a “PDA”) and suchlike. Such liquid crystal displays belong to a reflective, transmissive or transflective liquid crystal device.

The reflective liquid crystal display provides reflective display by guiding surrounding light into an inside of a liquid crystal panel and reflecting the light with a reflective layer. The transmissive liquid crystal display device provides transmissive display by emitting light from a light source provided on the backside of a liquid crystal panel (so-called backlight).

And the transflective liquid crystal display device provides both reflective display using surrounding light and transmissive display using light emitted from a backlight. Such transflective liquid crystal display devices are installed in mobile apparatuses such as a mobile phone, a PDA or a digital camera, since they can provide recognizable display regardless of surrounding brightness.

In such a transflective liquid crystal display device, a pixel region has a reflective region used for the reflective display and a transmissive region used for the transmissive display. In the transmissive region, light emitted from a backlight is transmitted through a color filter only once and emitted outside. In the reflective region, surrounding light after being transmitted through a color filter is reflected by a reflective layer, and transmitted through the color filter again to be emitted outside.

As described above, the number of times in which light for display is transmitted through a color filter is different between the transmissive region and the reflective region. And dark reflective display is provided because light is transmitted through the color filter two times in the reflective region. Therefore, the following methods have been proposed.

A first method can provide bright reflective display, because a reflective region and a transmissive region have the same configuration in a color filter, that is, they are formed from the same color material and have the same film thickness, and an uncolored region is formed in the reflective region, as disclosed in Japanese Kokai Publication No. 2000-111902.

A second method can provide bright reflective display, because a color filter suitable for reflective display is formed in a reflective region and a color filter suitable for transmissive display is formed in a transmissive region, as disclosed in Japanese Kokai Publication No. 2001-183646.

A third method can provide bright reflective display, since a color filter of a reflective region is formed of the same color material as that of the transmissive region and formed so as to have a film thickness thinner than that in the transmissive region, as disclosed in Japanese Publication No. 2002-296582, Japanese Publication No. 2004-20648, and Japanese Publication No. 2004-85986.

### SUMMARY OF THE INVENTION

The above-mentioned first method secures brightness, but provides display having low color reproducibility, because the display is provided by a mixed color of light transmitted through the filter such as red (R), green (G), or blue (B) and white light transmitted through the uncolored region.

The above-mentioned second method provides display having the same brightness as in the first method, but having high color reproducibility than that in the first method, because the color filter having a desired property can be formed in the reflective region. However, the color filter needs to be formed using twice colors than those of a usual color filter, which is an industrially extremely serious problem of doubling manufacturing processes of the color filter.

The above-mentioned third method provides display having the same brightness as in the first method, but having high color reproducibility than that in the first method, because the color filter of the reflective region is formed so as to have a film thickness thinner than that of the color filter of the transmission region. And the number of colors for the filter in the third method does not need to be increased. Therefore, the third method is the most excellent method among the three methods from a comprehensive standpoint.

For the color filter of the reflective region, a color filter capable of providing more bright display, for example, a color filter having a NTSC ratio of approximately 5 to 15% is recently needed. And for the color filter of the transmissive region, a color filter having a NTSC ratio of approximately 50 to 70% is needed.

In order to satisfy the needs, in the third method, the color filter of the reflective region should be formed so as to have a film thickness five times thinner than that of the color filter of the transmissive region. However, the third method can not satisfy the needs actually, because it is extremely difficult to stably manufacture such a color filter with the thin film thickness under the current manufacturing technology.

The present invention has been made in view of the above-mentioned problems. And it is an object of the present invention to provide a transflective liquid crystal display device capable of providing reflective display having a preferable brightness and color reproducibility.

A color filter substrate of the present invention is a color filter substrate comprising a color filter having n colors of filters each colored with one color selected from n colors including at least three colors, at least one color of filters among the n colors of filters each having a first region with a first film thickness, a second region with a second film thickness thinner than that of the first region, and an uncolored region formed in the second region. That is, the color filter substrate of the present invention is a color filter substrate comprising a color filter, the color filter having n colors of filters each colored with one color selected from n colors including at least three colors, at least one color of filters among the n colors of filters having a first region with a first film thickness, a second region with a second film thickness thinner than that of the first region, and an uncolored region formed in the second region.

A liquid crystal display device of the present invention comprising a color filter having n colors of filters each colored with one color selected from n colors including at least three colors, any one color of filters among the n colors of filters being each formed in one pixel region of a plurality of pixel regions, and the pixel region having a reflective region for reflective display and a transmissive region for transmissive display, and in the reflective region, at least one color of filters among the n colors of filters having: a film thickness thinner than that of the transmissive region; and an uncolored region. That is, the liquid crystal display device of the present invention is a liquid crystal display device having a plurality of pixel regions including a reflective region for reflective display and a transmissive region for transmissive display, the liquid crystal display device comprising a color filter having n colors of filters each colored with one color selected from n colors including at least three colors, any one color of filters among the n colors of filters being each formed in one pixel region of the plurality of pixel regions, and in the reflective region, at least one color of filters of the n colors of filters having: a film thickness thinner than that of the transmissive region; and an uncolored region.

Furthermore, the liquid crystal display device of the present invention may be a liquid crystal display device, comprising: a backlight; a transparent electrode being disposed forward of the backlight and transmitting light from the backlight; a reflective layer being disposed forward of the backlight and reflecting light made incident from a front face; and a color filter being disposed forward of the transparent electrode and the reflective layer and having n colors of filters each colored with one color selected from n colors including at least three colors, the n colors of filters being each formed in one pixel region, and in an region forward of the reflective layer, at least one color of filters having an uncolored region and a region with a film thickness thinner than that of a region forward of the transparent electrode.

According to the present invention, the uncolored region is formed at a region having a thin film thickness in the color filter and the thin film region can originally provide bright display. Therefore, very bright display can be provided even if the uncolored region is small, and the small uncolored region can lower a reduction of the color reproducibility.

The present invention can provide a transflective liquid crystal display device capable of providing very bright reflective display having high color reproducibility.

### BRIEF DESCRIPTION OF THE DRAWINGS

FIG. 1 is a cross-sectional view showing a color filter substrate according to one embodiment of the color filter substrate of the present invention.

FIG. 2 is a cross-sectional view showing a color filter substrate according to another embodiment of the color filter substrate of the present invention.

FIG. 3 is a cross-sectional view showing a liquid crystal display device according to one embodiment of the liquid crystal display device of the present invention.

FIG. 4 is a graph showing a relation between color reproducibility and brightness.

FIGS. 5A to 5C are cross-sectional views of a color filter substrate in working example 1 and each shows a manufacturing process of the substrate.

FIG. 6 is a cross-sectional view of a color filter substrate in working example 1 and shows another manufacturing process of the substrate.

FIGS. 7A to 7D are cross-sectional views of a color filter substrate in working example 2 and each shows a manufacturing process of the substrate.

FIGS. 8A to 8J are cross-sectional views of a color filter substrate in working example 3 and each shows a manufacturing process of the substrate.

FIGS. 9A to 9G are cross-sectional views of a color filter substrate in working example 4 and each shows a manufacturing process of the substrate.

FIGS. 10A to 10E are cross-sectional views of a color filter substrate in working example 5 and each shows a manufacturing process of the substrate.

FIG. 11 is a cross-sectional view showing another embodiment of the color filter substrate in FIG. 10C.

FIGS. 12A and 12B are cross-sectional views of a color filter substrate in working example 6 and each shows a manufacturing process of the substrate.

FIGS. 13A to 13C are cross-sectional views of a color filter substrate in working example 7 and each shows a manufacturing process of the substrate.

FIG. 14 is a cross-sectional view showing another embodiment of the color filter in FIG. 13A.

### EXPLANATION OF SYMBOLS AND NUMERALS

1: Glass substrate
2: Filter
3: Protective film
4: Resin film
5: Black mask
11: Glass substrate
12: Reflective electrode
13: Transparent electrode
20: Liquid crystal layer
21: Photosensitive colored resin film
22: Colored resin film
23: First photoresist film
24: Second photoresist film
25: Aperture
30: Photomask
31: translucent region
32: Halftone region
33: Light-shielding region
34: First photomask
35: Second photomask
a: First region
b: Second region
c: Uncolored region
d: One pixel region
e: Reflective region
f: Transmissive region

### BEST MODES FOR CARRYING OUT THE INVENTION

A color filter substrate and a liquid crystal display device according to the embodiments of the present invention will, hereinafter, be described with reference to drawings.

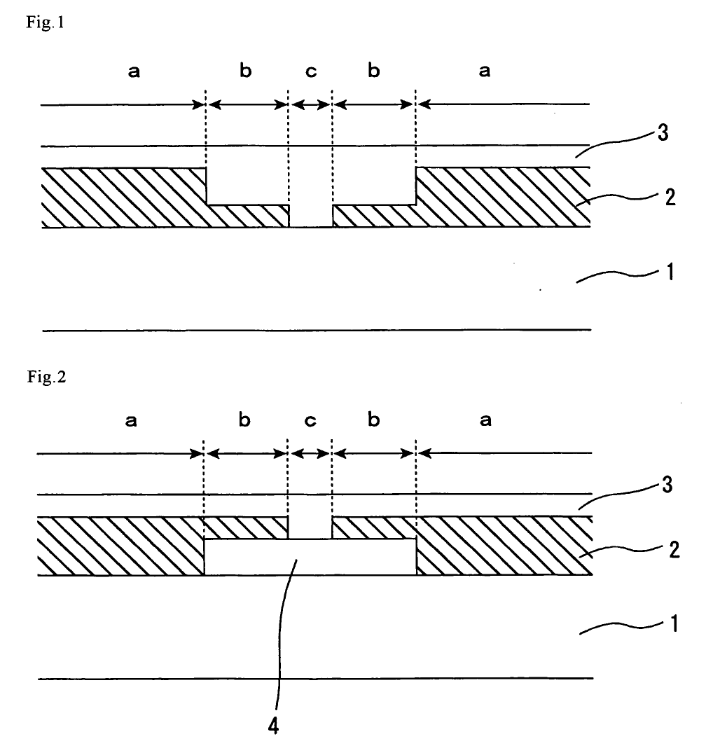

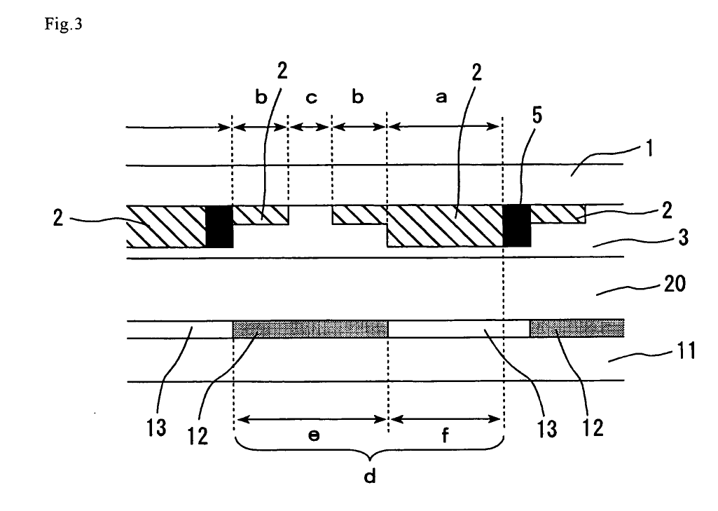

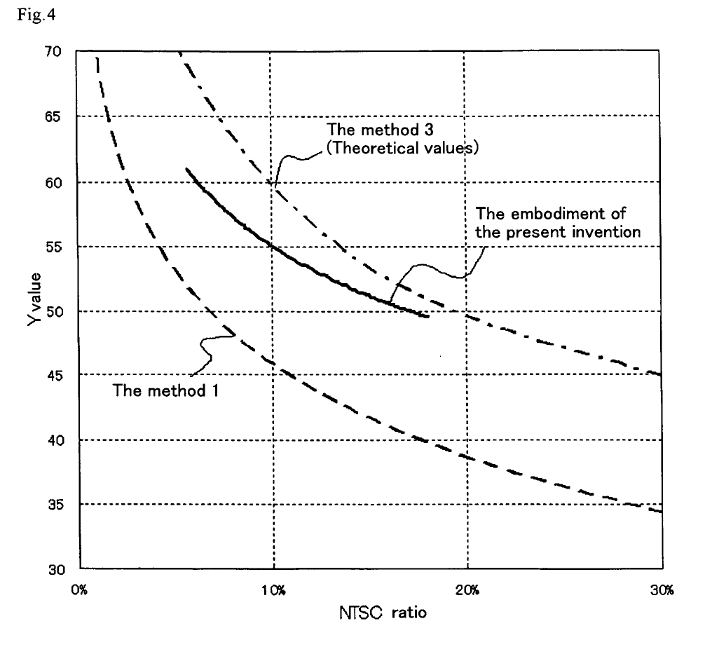

FIG. 1 is a cross-sectional view showing a color filter substrate according to one embodiment of the color filter substrate of the present invention. FIG. 2 is a cross-sectional view showing the color filter substrate according to another embodiment of the color filter substrate of the present invention. FIG. 3 is a cross-sectional view showing a liquid crystal display device according to one embodiment of the liquid crystal display device of the present invention. FIG. 4 is a graph showing a relation between color reproducibility and brightness.

Configurations of the color filter substrates are firstly described. As shown in FIG. 1, the color filter substrate according to one embodiment of the color filter substrate of the present invention has, for example, a red (R) filter, a green (G) filter, and a blue (B) filter each formed on one surface of a glass substrate 1. Only one color of filter 2 is shown in FIG. 1 for ease of explanation. The R, G, and B filter mainly transmit red component, green component and blue component of incident light, respectively.

The filter 2 has a first region a and a second region b formed so as to have a film thickness thinner than that of the first region a. In the filter 2, the first region a and the second region b are formed from the same material, but they have different film thicknesses from each other. For example, the first region a has a thickness of approximately 2 μm, and the second region b has a thickness of approximately 1 μm. And the second region b has, on the inside, an uncolored region c where the filter 2 is not formed. Such a color filter substrate is hereinafter referred to as a color filter of embodiment 1.

A protective film 3 for filling the differences in film thickness among the regions a to c may be formed so as to cover the regions a to c. A black mask (light-shielding film) may be formed between the filters 2, if necessary.

As shown in FIG. 2, the color filter substrate according to another embodiment of the color filter substrate of the present invention has a resin film 4 formed on one surface of the glass substrate 1, and thereon, a red (R) filter, a green (G) filter, and a blue (B) filter each formed. Only one color of filter 2 is shown in FIG. 2 for ease of explanation. The R, G, and B filter mainly transmit red component, green component and blue component of incident light, respectively.

The filter 2 has the first region a and the second region b formed so as to have a film thickness thinner than that of the first region a due to the resin film 4. In the filter 2, the first region a and the second region b are formed from the same material, but they have different film thicknesses from each other. For example, the first region a has a thickness of approximately 2 μm, and the second region b has a thickness of approximately 1 μm. And the second region b has, on the inside, the uncolored region c where the filter 2 is not formed. Such a color filter substrate is hereinafter referred to as a color filter of embodiment 2.

The protective film 3 for filling the differences in film thickness among the regions a to c may be formed so as to cover the regions a to c. The black mask (light-shielding film) may be formed between the filters 2, if necessary.

In the embodiments of the color filter substrate of the present invention, the glass substrate 1 may be a resin substrate, and it is not especially limited as long as it is formed from a material capable of transmitting light. The protective film 3 and the resin film 4 are not especially limited as long as they are formed from a material capable of transmitting light. The filter 2 is not limited to three colors of R, G, and B. Three colors of yellow, cyan, and magenta may be used, and four or more colors may be used.

A manufacturing method of the color filter substrates according to the embodiments of the color filter substrate of the present invention is not especially limited. And known methods described in the Japanese Kokai Publication No. 2002-296582, the Japanese Kokai Publication No. 2004-20648, and the Japanese Kokai Publication No. 2004-85986 may be used. And any method other than the methods described in the above-mentioned patent documents may be used as long as a resin film having different film thicknesses can be formed.

Working examples of the manufacturing method of the color filter substrate according to the embodiments of the color filter substrate of the present invention are hereinafter described. In the following working examples, a pigment dispersion method is used, but the manufacturing method is not limited to the pigment dispersion method. For example, a dyeing process, a printing method, an electrodeposition method may be used. The pigment dispersion method is classified into a photo-etching method, a color resist method, and a transfer method in terms of filter material and manufacturing process.

### WORKING EXAMPLE 1

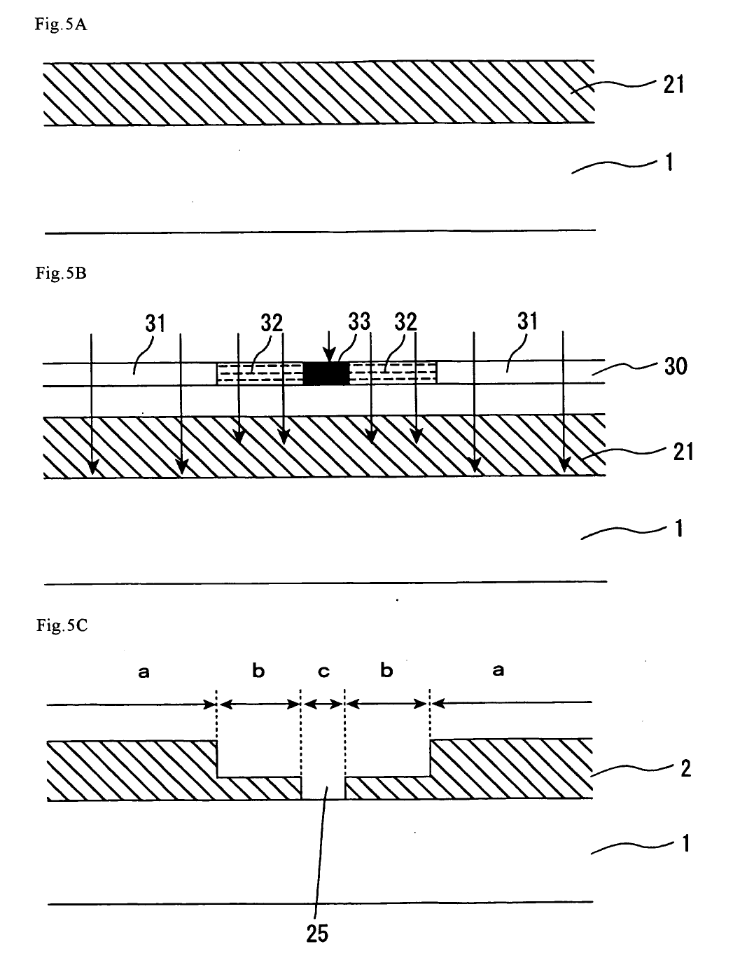

Working example 1, which is one example of the manufacturing method of the color filter substrate according to the embodiment 1, is explained with reference to FIGS. 5A to 5C. FIGS. 5A to 5C are cross-sectional views of a color filter substrate in this working example and each shows a manufacturing process of the substrate. In this working example, the color filter substrate is manufactured by the color resist method or the transfer method, using a photomask (halftone mask) having two or more translucent regions having different transmissivities from each other and a light-shielding region.

Firstly, a photosensitive colored resin film 21, which is a photoresist film in which a pigment, such as red (R), green (G), or blue (B) is dispersed, is formed on a glass substrate 1, as shown in FIG. 5A. The photosensitive colored resin film 21 has a film thickness of 2 μm. As the photosensitive colored resin film 21, for example, a photosensitive acrylic resin in which pigments are dispersed may be used. A negative type photoresist film is used in this working example, but a positive type photoresist film may be used. The pigments for such as red (R), green (G), and blue (B) are not especially limited. As the method for forming the photosensitive colored resin film 21, application method such as a spin coating method and a roll coating method using liquid resist (pigment-dispersed type photosensitive solution), and a dry film resist method of transferring a film (dry film) with a photosensitive colored layer provided on a support may be used.

Then, the photosensitive colored resin film 21 is exposed using a photomask (halftone mask) 30 having a translucent region 31, a halftone region 32, and a light-shielding region 33, as shown in FIG. 5B. The translucent region 31 is formed at a position corresponding to the first region a, the halftone region 32 is formed at a position corresponding to the second region b, and the light-shielding region 33 is formed at a position corresponding to the uncolored region c. The halftone region 32 has a transmissivity smaller than that of the translucent region 31 and larger than that of the light-shielding region 33.

The negative type photoresist film is used in this working example. Therefore, the use of the halftone mask mentioned above enables the photosensitive colored resin film 21 at the translucent region 31 to be hardly dissolved in a subsequent development. On the other hand, the photosensitive colored resin film 21 at a position corresponding to the halftone region 32 is somewhat dissolved, and the photosensitive colored resin film 21 at a position corresponding to the light-shielding region 33 is easily dissolved.

The configuration of the halftone region 32 is not especially limited, and the region 32 may have a fine aperture pattern and have a film thickness thinner than that of the light-shielding region 33. The shape of the aperture pattern may be such as a slit pattern and a dot pattern. The size of each pattern and the film thickness may be appropriately determined depending on a desired film thickness of the second region b.

The photosensitive colored resin film 21 may be exposed by a lens stepping method, a proximity method, or a mirror projection method, for example. And the exposure amount may be appropriately determined depending on a film thickness and a sensitivity of the photosensitive colored resin film 21.

Then, the photosensitive colored resin film 21 is developed with a developer to form a filter 2 having a first region a with a thickness of approximately 2 μm at a region corresponding to the translucent region 31, a second region b with a thickness of approximately 1 μm at a region corresponding to the halftone region 32 and an uncolored region c formed as an aperture 25 at a region corresponding to the light-shielding region 33.

As the developer, an alkaline developer containing a surfactant is preferably used, and for example, a TMAH solution (Tetramethyl ammonium hydoroxide solution) containing a nonionic surfactant may be mentioned. And it is preferable that the Photosensitive colored resin film 21 is baked after the development, and it is more preferable that the baked Photosensitive colored resin film 21 is washed.

Then, filters of the rest colors among red (R), green (G), blue (B) and the like are also formed on the glass substrate 1 in the same manner and the protective film 3 is provided so as to cover the regions a to c, and thereby the color filter substrate of the embodiment 1 is manufactured.

As mentioned above, the first region a, the second region b having a film thickness thinner than that of the first region a and the uncolored region formed inside the second region b can be simultaneously formed with one mask having the halftone region.

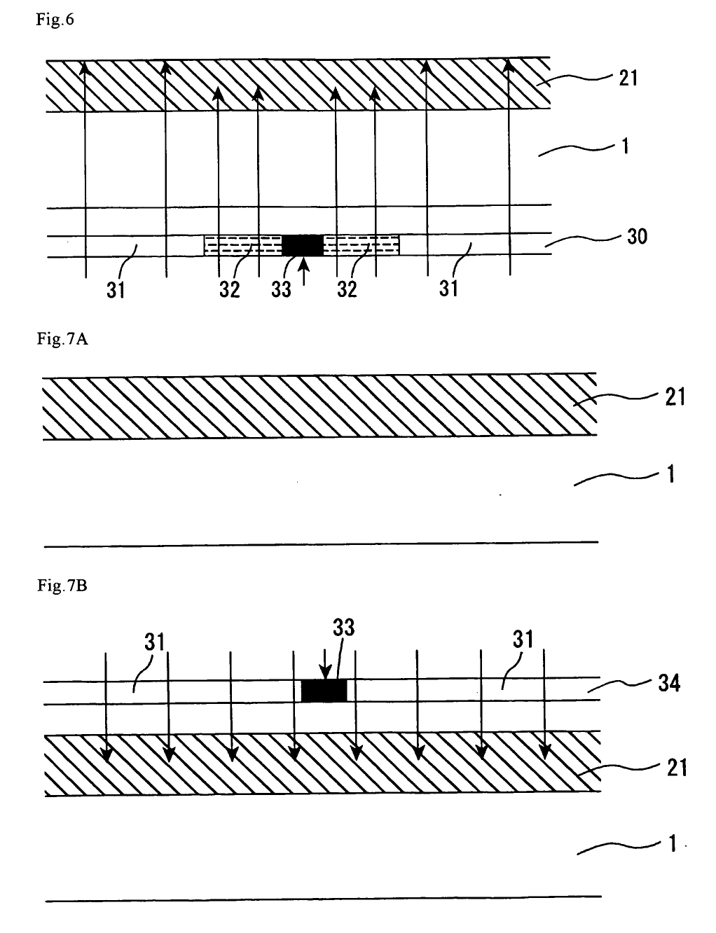

In the exposure of this working example, the photomask 30 is disposed on the photosensitive colored resin 21 side. However, the photomask 30 may be disposed on the glass substrate 1 side and the photosensitive colored resin 21 is exposed from the glass substrate 1 side to form the filter 2, as shown in FIG. 6. The photosensitive colored resin 21 at a position remaining as the filter 2 is attached firmly to the glass substrate 1. Therefore, the aperture 25 can be more finely formed with accuracy, if the photosensitive colored resin 21 is exposed from the glass substrate 1 side.

### WORKING EXAMPLE 2

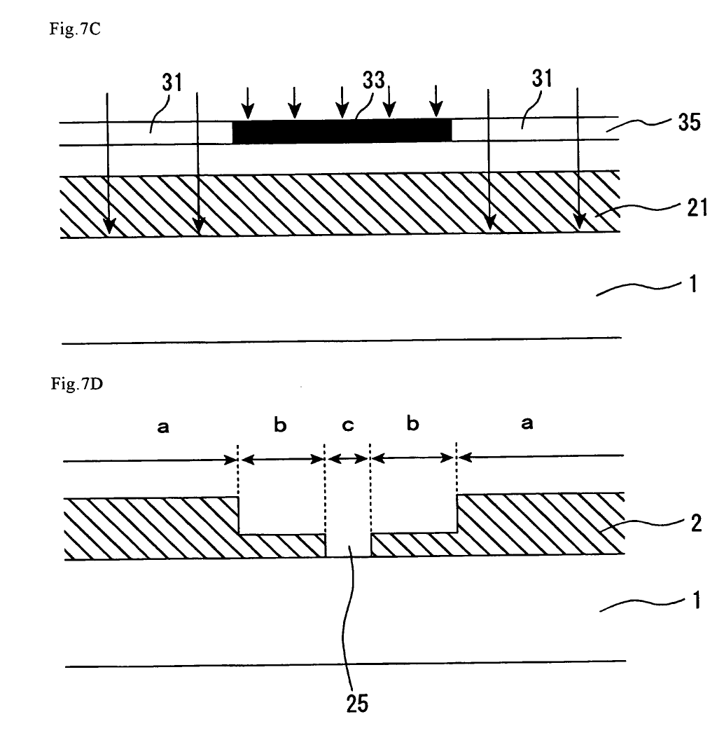

Working example 2, which is one example of the manufacturing method of the color filter substrate according to the embodiment 1, is explained with reference to FIGS. 7A to 7D. FIGS. 7A to 7D are cross-sectional views of a color filter substrate in this working example and each shows a manufacturing process of the substrate. In this working example, the color filter substrate is manufactured by the color resist method or the transfer method, using two photomasks. The color filter substrate of this working example is manufactured in the same manner as in working example 1, except for configurations of a mask and an exposure condition. Therefore, explanations of contents that overlap between working example 1 and 2 are omitted.

Firstly, the photosensitive colored resin film 21 is formed on the glass substrate 1, as shown in FIG. 7A. Then, a first exposure is provided for the photosensitive colored resin film 21 at a lower exposure amount from above a first photomask 34 having a translucent region 31 and a light-shielding region 33, as shown in FIG. 7B. The translucent region 31 is formed at positions corresponding to the first region a and the second region b. And the light-shielding region 33 is formed at a position corresponding to the uncolored region c.

Then, from above a second photomask 35 having a translucent region 31 and a light-shielding region 33, a second exposure is provided for the photosensitive colored resin film 21 at an exposure amount higher than that of the first exposure so as to make the photosensitive colored resin film 21 hardly developed, as shown in FIG. 7C. The translucent region 31 is formed at a position corresponding to the first region a. And the light-shielding region 33 is formed at positions corresponding to the second region b and the uncolored region c.

Thus, the photosensitive colored resin film 21 is exposed at different exposure amounts. And thereby, the photosensitive colored resin film 21 exposed at the higher exposure amount is hardly developed in a successive development, but the photosensitive colored resin film 21 exposed at the lower exposure amount is developed to some extent. Therefore, a filter having different film thicknesses can be formed.

Then, the photosensitive colored resin film 21 is developed to form a filter 2 having the first region a with a thickness of approximately 2 μm at the region exposed at the higher exposure amount, the second region with a thickness of approximately 1.5 μm at the region exposed at the lower exposure amount and the uncolored region c formed as the aperture 25 at the region not exposed, as shown in FIG. 7D.

Then, filters of the rest colors among red (R), green (G), blue (B) and the like are also formed on the glass substrate 1 in the same manner and the protective film 3 is formed so as to cover the regions a to c, and thereby the color filter substrate of the embodiment 1 is manufactured.

In this working example, the filter having different film thicknesses and the aperture can be formed, without the halftone mask, by exposing the photosensitive colored resin film 21 at different exposure amounts.

### WORKING EXAMPLE 3

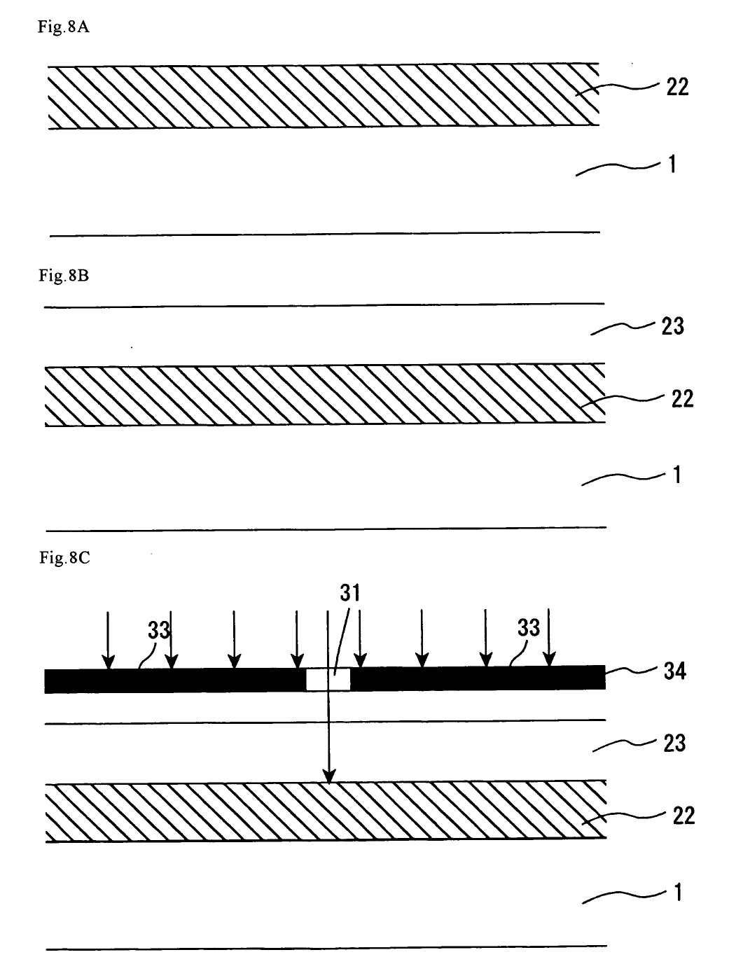

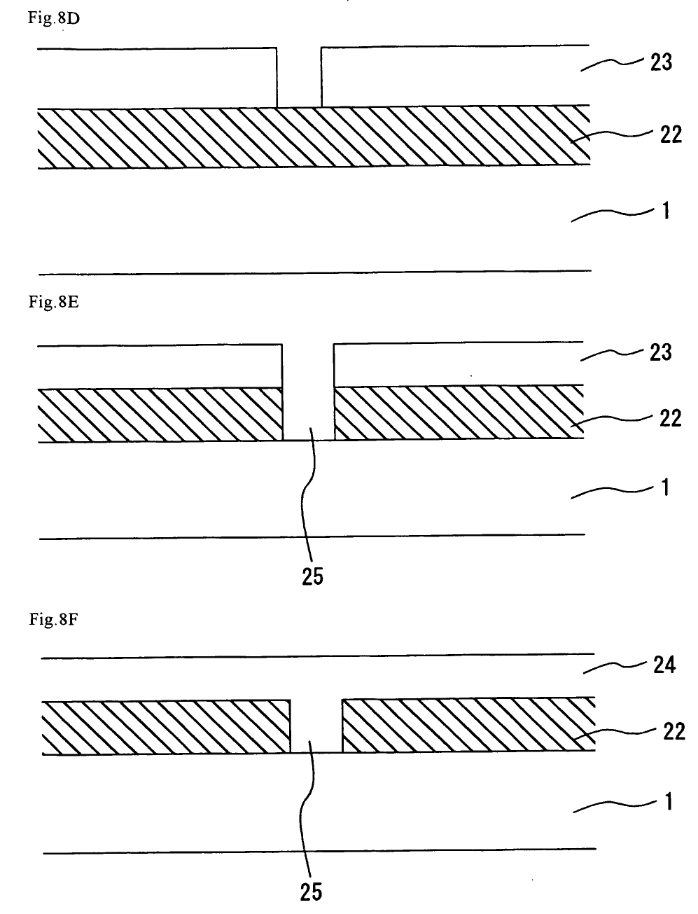

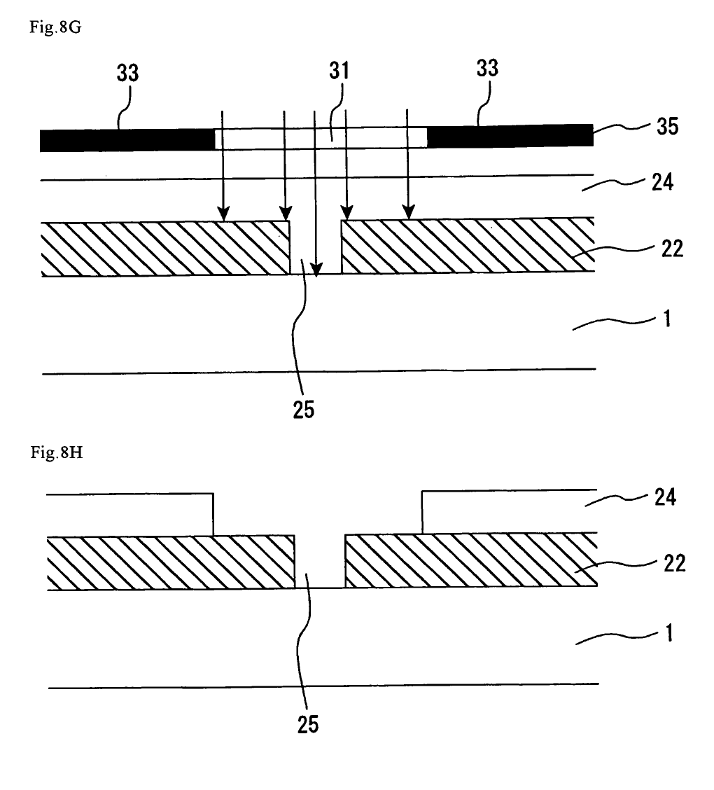

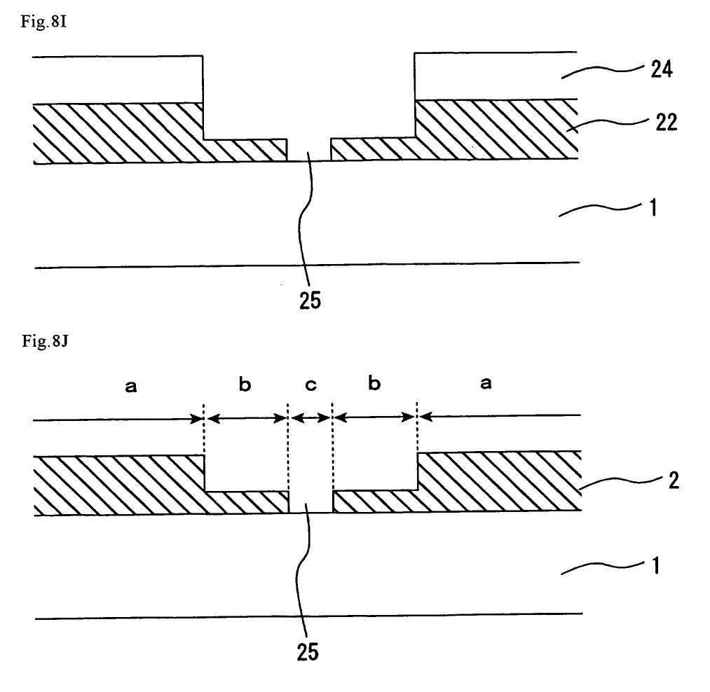

Then, Working example 3, which is one example of the manufacturing method of the color filter substrate according to the embodiment 1, is explained with reference to FIGS. 8A to 8J. FIGS. 8A to BJ are cross-sectional views of a color filter substrate in this working example and each shows a manufacturing process of the substrate. In this working example, the color filter substrate is manufactured by the photo-etching method.

Firstly, a colored resin film 22, in which a color material, for example, red (R), green (G), or blue (B) is dispersed, is formed on the glass substrate 1, as shown in FIG. 8A. The colored resin film 22 has a film thickness of 2 μm. As the colored resin film 22, a resin such as polyimide, in which a pigment is dispersed, may be used. The pigment for such as red (R), green (G), or blue (B) is not especially limited.

Then, a first photoresist film 23 is formed on the colored resin film 22, as shown in FIG. 8B. A positive type photoresist film is used as the first photoresist film 23. The colored resin film 22 and the first photoresist film 23 are formed in the same manner as in the photosensitive colored resin film 21 of working example 1.

Then, the first photoresist film 23 is exposed with the photomask 34 having the translucent region 31 and the light-shielding region 33, as shown in FIG. 8C. The light-shielding region 33 is formed at positions corresponding to the first region a and the second region b. And the translucent region 31 is formed at a position corresponding to the uncolored region c.

Then, the first photoresist film 23 is developed to be patterned, as shown in FIG. 8D. The same developer as in working example 1 is used.

Then, using the first photoresist film 23 as a mask, the colored resin film 22 at a region corresponding to the uncolored region c is etched until the glass substrate 1 is revealed to form an aperture 25, as shown in 8E.

The etching process is preferably carried out by a wet etching process using the same alkaline developer as the above-mentioned developer. Thereby, the patterning of the first photoresist film 23 and the etching of the colored resin film 22 are simultaneously carried out, which can simplify the manufacturing process.

Successively, the first photoresist film 23 is separated from the colored resin film 22, and then a second photoresist film 24 is formed on the glass substrate 1 and the colored resin film 22, as shown in FIG. 8F.

Then, the second photoresist film 24 is exposed using a second photomask 35 having the translucent region 31 and the light-shielding region 33, as shown in FIG. 8G.

The translucent region 31 is formed at positions corresponding to the second region 31 and the uncolored region c, and the light-shielding region 33 is formed at a position corresponding to the first region a.

Then, the second photoresist film 24 is developed with the above-mentioned developer to be patterned, as shown in FIG. 8H.

Then, the colored resin film 22 at a position corresponding to the second region b is etched so as to have a film thickness of approximately 0.8 μm using the photoresist film 24 as a mask, as shown in FIG. 8I.

Then, the second photoresist film 24 is separated from the colored resin film 22 to form a filter 2 having the first region a with a film thickness of approximately 2 μm, the second region b with a film thickness of approximately 0.8 μm and the uncolored region c formed as the aperture 25.

Then, filters of the rest colors among red (R), green (G), blue (B) and the like are also formed on the glass substrate 1 in the same manner and the protective film 3 is formed so as to cover the regions a to c, and thereby the color filter substrate of the embodiment 1 is manufactured.

### WORKING EXAMPLE 4

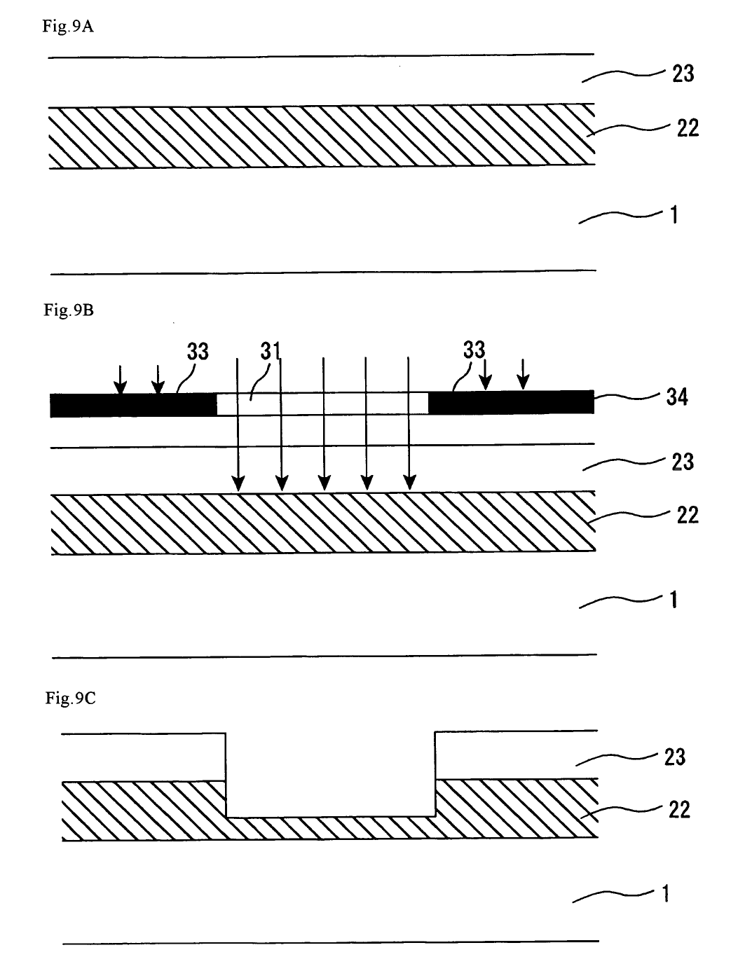

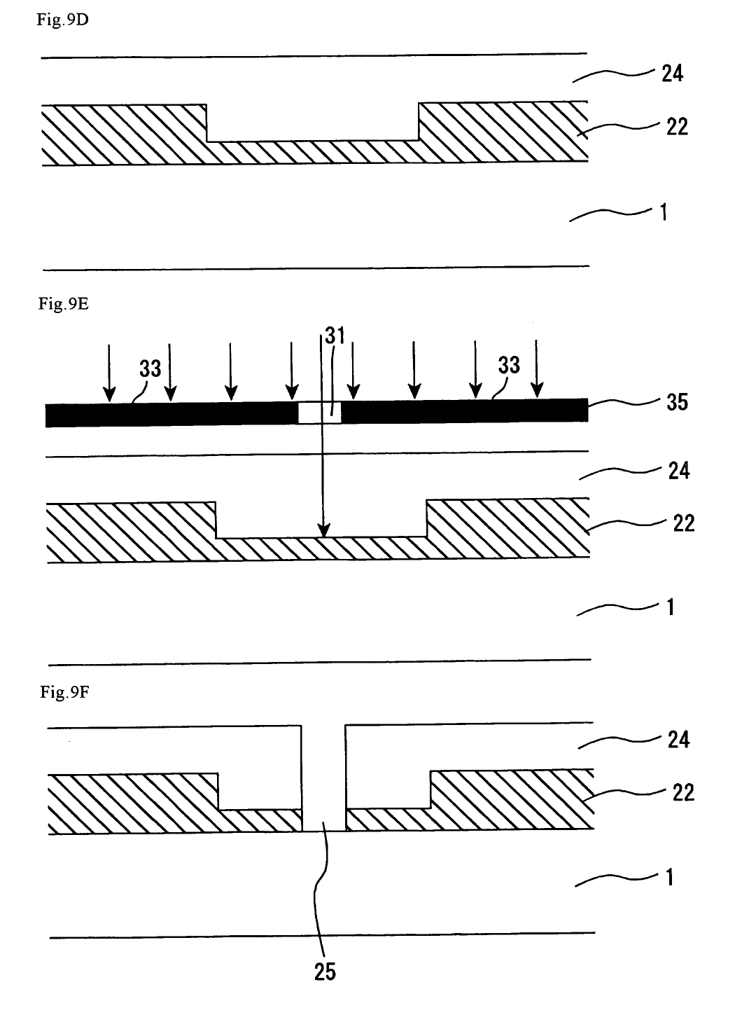

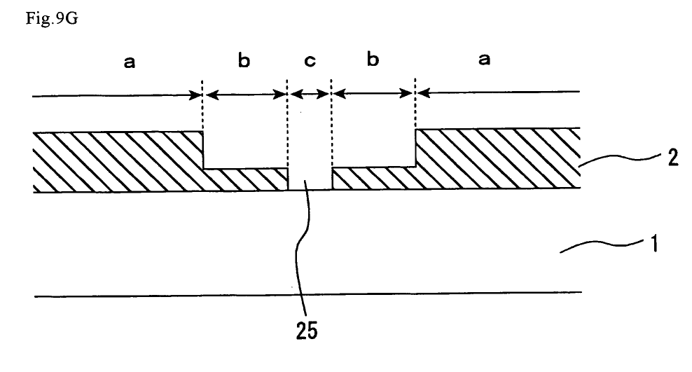

Working example 4, which is one example of the manufacturing method of the color filter substrate according to the embodiment 1, is explained with reference to FIGS. 9A to 9G. FIGS. 9A to 9G are cross-sectional views of a color filter substrate in this working example and each shows a manufacturing process of the substrate. In this working example, the color filter substrate is manufactured by the photo-etching method. The color filter substrate of this working example is manufactured in the same manner as in working example 3, except for a configuration of a mask and an condition of etching. Therefore, explanations of contents that overlap between working example 3 and 4 are omitted.

Firstly, the colored resin film 22 and successively the first photoresist film 23 are formed on the glass substrate 1, as shown in FIG. 9A. Then, a first photoresist film 23 is exposed with the first photomask 34 having the translucent region 31 and the light-shielding region 33, as shown in FIG. 9B. The translucent region 31 is formed at positions corresponding to the second region b and the uncolored region c, and the light-shielding region 33 is formed at a position corresponding to the first region a.

Successively, the first photoresist film 23 is developed to be patterned. And then, the colored resin film 22 at positions corresponding to the second region b and the uncolored region c is etched so as to have a film thickness of approximately 1.2 μm using the first photoresist film 23 as a mask, as shown in FIG. 9C.

Then, the first photoresist resin film 23 is separated from the colored resin film 22 to form the second photoresist film 24 on the glass substrate 1 and the colored resin film 22, as shown in FIG. 9D.

Then, the second photoresist film 24 is exposed using the second photomask 35 having the translucent region 31 and the light-shielding region 33, as shown in FIG. 9E. The light-shielding region 33 is formed at positions corresponding to the first region a and the second region b, and the translucent region 31 is formed at a position corresponding to the uncolored region c. Successively, the second photoresist film 24 is developed to be patterned. And then, using the second photoresist film 25 as a mask, the colored resin film 22 at a position corresponding to the uncolored region c is etched until the glass substrate 1 is revealed to form the aperture 25, as shown in FIG. 9F.

Then, the second photoresist film 24 is separated from the colored resin film 22 to form a filter 2 having the first region a with a film thickness of 2 μm, the second region b with a film thickness of 1.2 μm and the uncolored region c formed as the aperture 25, as shown in FIG. 9G.

Then, filters of the rest colors among red (R), green (G), blue (B) and the like are also formed on the glass substrate 1 in the same manner and the protective film 3 is formed so as to cover the regions a to c, and thereby the color filter substrate of the embodiment 1 is manufactured.

Hereinafter, manufacturing methods of the color filter substrate according to the embodiment 2 are described. The color filter substrate of the embodiment 2 has the same configuration as in the color filter substrate of the embodiment 1, except that an uncolored resin film 4 is formed at positions corresponding to the second region b and the uncolored region c on the glass substrate 1.

### WORKING EXAMPLE 5

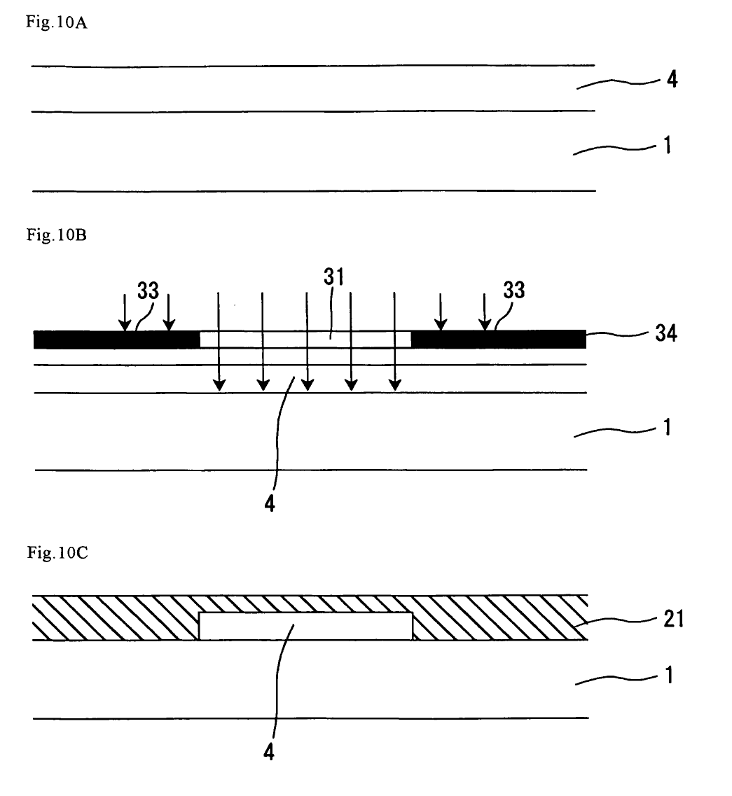

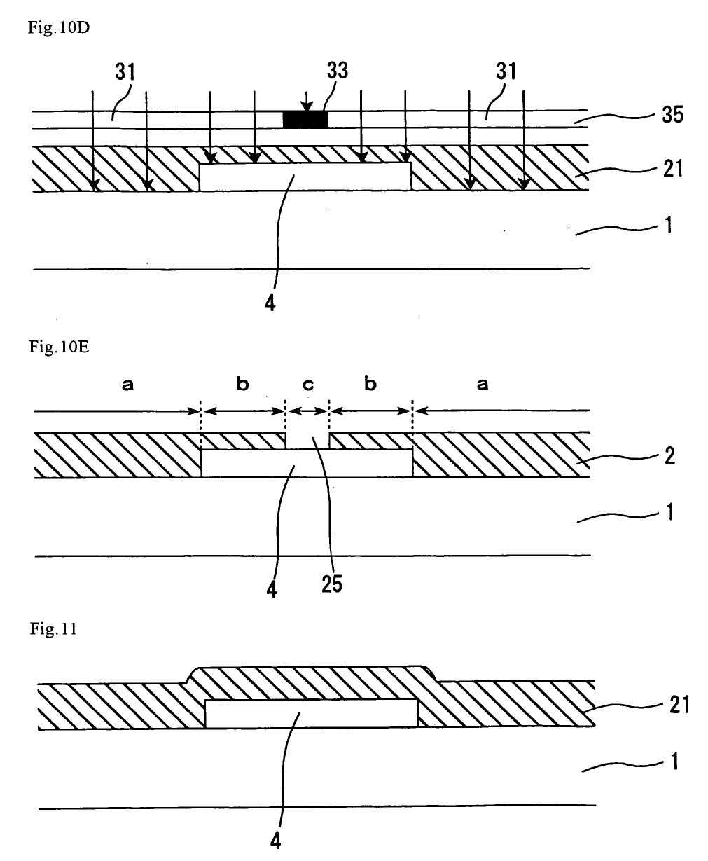

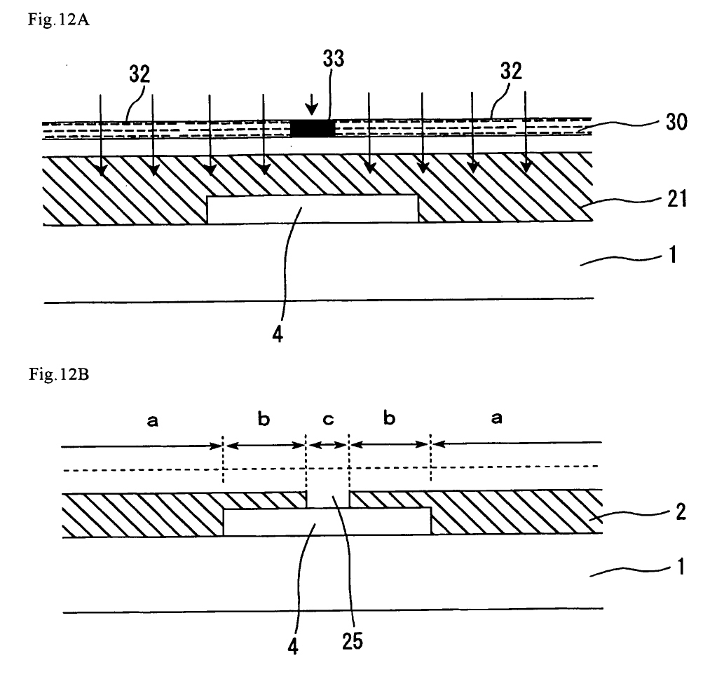

Working example 5, which is one example of the manufacturing method of the color filter substrate according to the embodiment 2, is explained with reference to FIGS. 10A to 10E. FIGS. 10A to 10E are cross-sectional views of a color filter substrate in this working example and each shows a manufacturing process of the substrate. In this working example, the color filter substrate is manufactured by the color resist method or the transfer method. The resin film 4 and the photosensitive colored resin film 21 are formed, exposed and developed in the same manner as in the photosensitive colored resin film 21 of working example 1. Therefore, explanations of contents that overlap between working example 1 and 5 are omitted.

Firstly, the resin film 4 having photosensitivity and no color is formed on the glass substrate 1, as shown in 10A. The resin film 4 is not especially limited as long as it is a material capable of transmitting light, and an acrylic resin and the like may be mentioned. A negative type photoresist film is used in this working example, but a positive type photoresist film may be used.

Then, the resin film 4 is exposed and developed using the first photomask 34 to form a strip-shaped resin film 4 at positions corresponding to the second region b and the uncolored region c, as shown in FIG. 10B.

Then, the photosensitive colored resin film 21, which is a photoresist film in which a pigment such as red (R), green (G), or blue (B) is dispersed, is formed on the glass substrate 1 and the resin film 4, as shown in FIG. 10C. The same pigments and photosensitive colored resin film 21 as those in working example 1 are used and the photosensitive colored resin film 21. The photosensitive colored resin film 21 on the glass substrate 1 has a film thickness of 2 μm. The photosensitive colored resin film 21 on the resin film 4 has a film thickness of approximately 1 μm. The resin film 4 is formed so as to be strip-shaped in this working example, but may be formed so as to be a plurality of island-shaped, as long as itis formed inside the second region b and the uncolored region c.

Then, the photosensitive colored resin film 21 is exposed using the second photomask 35 having the translucent region 31 and the light-shielding region 33, as shown in FIG. 10D. The translucent region 31 is formed at positions corresponding to the first region a and the second region b, and the light-shielding region 33 is formed at a position corresponding to the uncolored region c.

Then, the photosensitive colored resin film 21 is developed to form a filter 2 having the first region a with a thickness of approximately 2 μm, the second region b with a thickness of approximately 1 μm, and the uncolored region c formed as the aperture 25, as shown in FIG. 10E.

Then, filters of the rest colors among red, (R), green (G), blue (B) and the like are also formed on the glass substrate 1 in the same manner and the protective film 3 is formed so as to cover the regions a to c, and thereby the color filter substrate of the embodiment 2 is manufactured.

Accordingly, the formation of the resin film 4 allows for an easy formation of the filter 2 having the first region a, the second region b with a film thickness thinner than that of the first region, and the uncolored region c.

In FIGS. 10C to 10E, the photosensitive colored resin film 21 having a flat surface is used for ease of explanation. However, in practice, the resin film 4 has a film thickness of approximately 3 μm and the photosensitive colored resin film 21 has a film thickness of 2 μm. Therefore, the photosensitive colored resin film 21 often has unevenness around the edges of the resin film 4 in the color filter substrate having the resin film 4 according to the embodiment 2. Even in this case, the first region a can be formed so as to have a film thickness thinner than that of the second region b.

### WORKING EXAMPLE 6

Working example 6, which is one example of the manufacturing method of the color filter substrate according to the embodiment 2, is explained with reference to FIGS. 12A and 12 B. FIGS. 12A and 12B are cross-sectional views of a color filter substrate in this working example and each shows a manufacturing process of the substrate. In this working example, the color filter substrate is manufactured by the color resist method or the transfer method. The color filter substrate of this working example is manufactured in the same manner as in working example 5, except for an condition of an exposure process. Therefore, explanations of contents that overlap between working example 5 and 6 are omitted.

The photosensitive colored resin film 21 is exposed using the photomask 30 with the halftone region 32 and the light-shielding region 33 in the exposure process of this working example, as shown in FIG. 12A. The halftone region 32 is formed at positions corresponding to the first region a and the second region b, and the light-shielding region 33 is formed at a position corresponding to the uncolored region c.

Then, the photosensitive colored resin film 21 is developed to form a filter 2 having the first region a with a film thickness of approximately 1.5 μm, the second region b with a film thickness of approximately 0.75 μm and the uncolored region c formed as the aperture 25. In this working example, the photosensitive colored resin film 21 in the first region a and the second region b are made thinner and the filter 2 has a film thickness thinner than that of the photosensitive colored resin film 21 before the exposure and the development.

Then, filters of the rest colors among red, (R), green (G), blue (B) and the like are also formed on the glass substrate 1 in the same manner and the protective film 3 is formed so as to cover the regions a to c, and thereby the color filter substrate of the embodiment 2 is manufactured.

Accordingly, the use of the half tone mask enables the film thicknesses of the first region a and the second region b to be easily controlled to desired film thicknesses.

### WORKING EXAMPLE 7

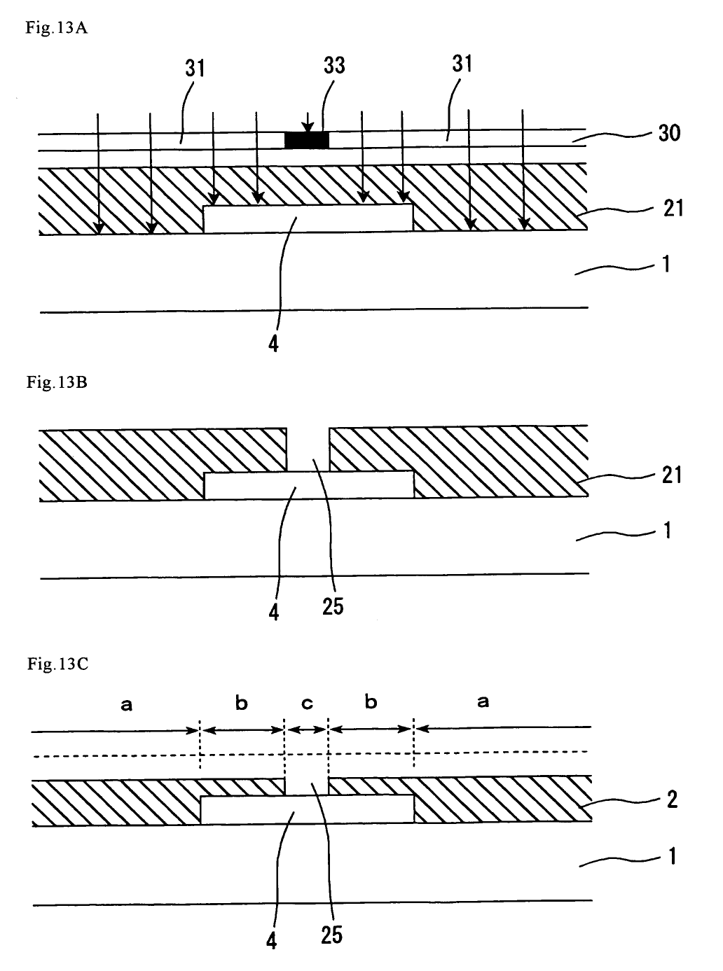

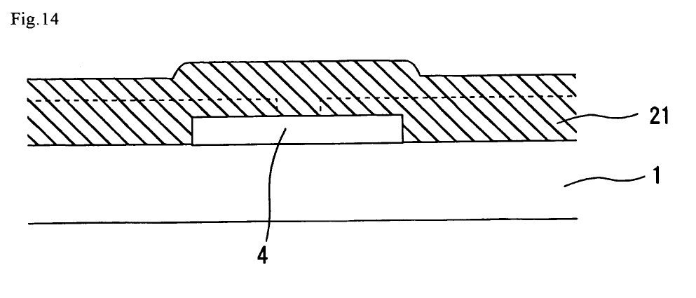

Working example 7, which is one example of the manufacturing method of the color filter substrate according to the embodiment 2, is explained with reference to FIGS. 13A to 13 B. FIGS. 13A to 13C are cross-sectional views of a color filter substrate in this working example and each shows a manufacturing process of the substrate. In this working example, the color filter substrate is manufactured by the color resist method or the transfer method and a polishing. The color filter substrate of this working example is manufactured in the same manner as in working example 6, except for conditions of process in an exposure and a thin film formation. Therefore, explanations of contents that overlap between working example 6 and 7 are omitted.

In the exposure process of this working example, the photosensitive colored resin film 21 is exposed using the photomask 30 having the translucent region 31 and the light-shielding region 33, as shown in FIG. 13A. The translucent region 31 is formed at positions corresponding to the first region a and the second region b, and the light-shielding region 33 is formed at a position corresponding to the uncolored region C.

Then, the photosensitive colored resin film 21 is developed to form the uncolored region c formed as the aperture 25, as shown in FIG. 13B. Then, filters of the rest colors among red, (R), green (G), blue (B) and the like are also formed on the glass substrate 1 in the same manner.

Then, the filter 2 surface is polished with CMP (Chemical Mechanical Polishing) and the like to make the filter 2 thinner, as shown in FIG. 13C. After that, the protective film 3 is formed so as to cover the regions a to c, and thereby the color filter substrate of the embodiment 2 is manufactured.

Accordingly, the polishing process enables the film thicknesses of the first region a and the second region b to be easily controlled to desired film thicknesses without the halftone mask. Furthermore, the polishing process also enables a color filter substrate with a flat surface to be produced, even if the photosensitive colored resin film 21 has a surface with a large unevenness due to the viscosity of the resin and the like, as shown in FIG. 14.

The color filter substrates having the above-mentioned configurations are preferably used for the transflective type liquid crystal display device. In this case, the first region a may correspond to the transmissive region providing transmissive display using light from a backlight and the like, and the second region b and the uncolored region c may correspond to the reflective region providing reflective display using surrounding light and the like.

Hereinafter, the liquid crystal display device according to one embodiment of the liquid crystal display device of the present invention is described. The liquid crystal display device according to one embodiment of the liquid crystal display device of the present invention has a configuration in which a liquid crystal layer 20 is disposed between the glass substrate 1 and a glass substrate 11, as shown in FIG. 3. One pixel region d has a reflective region e providing reflective display using surrounding light and the like, and a transmissive region f providing transmissive display using light from a backlight and the like.

The liquid crystal display device according to one embodiment of the liquid crystal display device of the present invention may comprise a polarizer and also a retarder stack. The polarizer and the retarder stack may be disposed on the glass substrate 1 or 11 of the liquid crystal layer 20 side, and also may be disposed on the glass substrate 1 or 11 of the other side. And the polarizer and the retarder stack may be formed by being attached to the glass substrate 1 or 11, and by being applied thereon.

For example, the filters 2 of red (R), green (G), and blue (B) are formed on the surface of the glass substrate 1 of the liquid crystal layer 20 side. And, if necessary, a black matrix 5 is formed between the filters 2. In this case, any one color of the filters 2 among R, G, and B are formed corresponding to one pixel region d, and any one color of the filters 2 are each formed in a plurality of pixel regions.

The filter 2 has the first region a with a thickness of approximately 2 μm and the second region b with a thickness of approximately 0.66 μm, which is formed so as to have a film thickness thinner than that of the first region a. In the filter 2, the first region a and the second region b are formed of the same material, but they have different film thicknesses from each other. And the second region b has, on the inside, the uncolored region c where the filter 2 is not formed. The protective film 3 for filling the differences in film thickness among the regions a to c may be formed so as to cover the regions a to c.

In the one pixel region d, the first region a is formed corresponding to the transmissive region f, and the second region b and the uncolored region c are formed corresponding to the reflective region e.

And the filters 2 are not limited to three colors of R, G, and B, and may be three colors of yellow, cyan, and magenta. And four or more colors may be used for the filters. The uncolored region c may be formed in only a suitable filter 2, for example, in only R filter, or in only R and B filter. Furthermore, the uncolored region c may have different areas in each color, for example, R filter may have an area different from that of G filter.

A reflective electrode 12 and a transparent electrode 13 are formed on the glass substrate 11 of the liquid crystal layer 20 side. The reflective electrode 12 serving as a reflective layer is an electrode exhibiting a function of light reflection, and it may contain metals such as Al, Ag, or an alloy thereof. The transparent electrode 13 is an electrode formed from a transparent electrical conducting material, such as ITO (indium-tin oxide) or IZO (indium-zinc oxide).

The reflective electrode 12 may be a reflective layer having no function as an electrode (hereinafter, also referred to as a nonelectrode type reflective layer), and an electrode may be separately formed. In this case, the nonelectrode type reflective layer may be formed on the glass substrate 11 of the other side of the liquid crystal layer 20. The nonelectrode type reflective layer or the reflective electrode may have an uneven surface so as to exhibit a light scattering property, or may have a specular surface. It is preferable that a light scattering layer is separately formed, if the nonelectrode type reflective layer or the reflective electrode has the specular surface. The light scattering layer may be used with the nonelectrode type reflective layer or the reflective electrode exhibiting the light scattering property.

The liquid crystal layer 20 corresponding to the reflective region e and the liquid crystal layer 20 corresponding to the transmissive region f may have different film thicknesses from each other, or have the same film thickness. The liquid crystal layer 20 may be formed from a liquid crystal material exhibiting a positive dielectric anisotropy or a negative dielectric anisotropy. A method for controlling alignment of the liquid crystal material may be a multi domain, an alignment division and the like, and it is not especially limited.

Hereinafter, a relationship of color reproducibility and brightness of a color filter is explained. In a transflective type liquid crystal display device, a color filter at a transmissive region transmits light once, and the color filter at a reflective region transmits light twice, and whereby display is provided. Therefore, if the color filter at the reflective region and the color filter at the transmissive region are formed from the same color material and have the same film thickness, the color filter at the reflective region theoretically has an optical density twice as much as that of the color filter at the transmissive region. That is, if the difference in the light source is not considered, the reflective display is equal to transmissive display provided using a color filter having an optical density or a film thickness twice as much as those of the reflective display. Therefore, the first or third method mentioned above as conventional technologies is needed.

However, as mentioned above, the first method provides display by a mixed color of light transmitted through the filter such as R, G, or B and white light transmitted through the uncolored region. Therefore, a brightness (Y value in the standard colorimetric system (XYZ) based on the CIE:Commission Internationale de l'Eclairage) can be secured, but display has a low color reproducibility, as shown in FIG. 4 with a broken line. That is, if reflective display having a NTSC ratio of approximately 5 to 15% is needed, the first method can not provide display having a sufficient brightness.

And as mentioned above, if the method 3 is employed, it is extremely difficult to stably manufacture a color filter capable of providing reflective display having a NTSC ratio of approximately 5 to 15% under the current manufacturing technology. For example, if a color filter having a NTSC ratio of 50% is used for the transmissive region, the reflective region can provide display having a NTSC ratio of approximately 30% at most. It is a limit of the manufacture of a thinner film under the current manufacturing technologies. FIG. 4 shows, with a chain dashed line, theoretical values when assuming that the method 3 can produce a thinner film.

The NTSC ratio herein used means a ratio of an area of a polygon showing a color reproduction range on the chromaticity diagram of standard calorimetric system (XYZ) based on the CIE. The area of a polygon serving as a standard is defined as an area of a triangle having R (x=0.670, y=0.330), G (x=0.210, y=0.710), and B (x=0.140, y=0.080) as vertexes. The NTSC ratio is determined by dividing an area of a polygonal expressed when the chromaticity coordinates (x, y) of light transmitted through an object color filter is shown on the chromaticity diagram of standard colorimetric system (XYZ) by the area of the standard triangle.

Even in the current manufacturing technology mentioned above, the present invention attains both brightness and color reproducibility. According to the method 1 shown in FIG. 4, the color reproducibility is considerably reduced if the uncolored region is formed in the color filter. However, according to the present invention, brightness can be originally secured to some extent because the color filter of the reflection region has a thinner film thickness, and therefore the uncolored region can be smaller than that in the method 1.

Therefore, the present invention improves the color reproducibility in the same brightness as in the method 1, or improves the brightness in the same color reproducibility as in the method 1, although the color reproducibility is lower than that in the above method 3, as shown in FIG. 4 with a continuous line.

As mentioned above, the present invention have the uncolored region at the region having a thinner film thickness of the color filter, and the thinner film region is capable of originally providing bright display, therefore, the present invention can provide very bright display even if the uncolored region is small. And the small uncolored region can lower the reduction of the color reproducibility.

1. A color filter substrate comprising a color filter,
the color filter having n colors of filters each colored with one color selected from n colors including at least three colors,
at least one color of filters among the n colors of filters having a first region with a first film thickness, a second region with a second film thickness thinner than that of the first region, and an uncolored region formed in the second region.

2. A liquid crystal display device having a plurality of pixel regions including a reflective region for reflective display and a transmissive region for transmissive display,
the liquid crystal display device comprising a color filter having n colors of filters each colored with one color selected from n colors including at least three colors, any one color of filters among the n colors of filters being each formed in one pixel region of the plurality of pixel regions, and
in the reflective region, at least one color of filters of the n colors of filters having:
a film thickness thinner than that of the transmissive region; and
an uncolored region.

3. A liquid crystal display device, comprising:
a backlight;
a transparent electrode being disposed forward of the backlight and transmitting light from the backlight;
a reflective layer being disposed forward of the backlight and reflecting light made incident from a front face; and
a color filter being disposed forward of the transparent electrode and the reflective layer and having n colors of filters each colored with one color selected from n colors including at least three colors,
the n colors of filters being each formed in one pixel region, and
in an region forward of the reflective layer, at least one color of filters having an uncolored region and a region with a film thickness thinner than that of a region forward of the transparent electrode.
